(19) United States
(12) Patent Application Publication
(10) Pub. No.: US 2011/0295416 A1
(43) Pub. Date: Dec. 1, 2011

(54) DOSING AND DISPENSING DEVICE

(76) Inventors: Sten-Magnus Aquilonius, Uppsala (SE); Sören Nygren, Knivsta (SE); Carl-Olof Sjöberg, Vasby (SE); Jan Kranse, Ostervala (SE)

(21) Appl. No.: 13/130,923

(22) PCT Filed: Nov. 19, 2009
(86) PCT No.: PCT/EP2009/008253

§ 371 Date: Aug. 8, 2011

(30) Foreign Application Priority Data
Nov. 27, 2008 (GB) 0821672.3

(51) Int. Cl. B65D 83/04; G06F 17/00; G06F 3/041; B65G 59/00

(52) U.S. Cl. 700/232; 221/200; 221/198; 221/98; 221/3; 345/173

(57) ABSTRACT

A hand held medicine dosing and dispensing device (10) comprising a housing (12) including a storage chamber (14) to store discrete units of medicine (16). The dispensing device (10) further includes a feed assembly (18) located between the storage chamber (14) and a dispenser (20) to feed individual units of medicine (16) from the storage chamber (14) to the dispenser (20). An impacter (22) is operably associated with the storage chamber (14) to agitate units of medicine (16) stored in the storage chamber (14). The impacter (22) includes a rigid element (24) fixedly connected at or towards one end (26) to a wall (28) of the storage chamber (14) and operably associated at or towards a second end (30) with an actuating mechanism (32) that deflects the second end (30) of the impacter (22) towards the wall (28) of the storage chamber (14) to strain the impacter (22) such that, when released, the strained impacter (22) moves towards the interior (34) of the storage chamber (14) and impacts against the units of medicine (16).

The invention relates to a hand held medicine dosing and dispensing device.

The drug therapies used to treat or otherwise control a number of chronic diseases such as, but not limited to, Parkinson's disease, epilepsy, cancer, depression, schizophrenia, diabetes, arthritis and asthma and diseases requiring anti-coagulants, anti-arrhythmics and/or analgesia often have a narrow therapeutic window and produce significant side effects when dosing is non-optimal.

The timing of doses is therefore critical to maintain drug levels within desired levels and it is important that administered doses are as accurate as possible to reduce the effects that can otherwise arise from over or under dosing.

In order to administer as accurate a dose as possible EP 1 058 660 B1 describes a procedure for dosing a medicine for dispensing to a single patient from a supply of equally large units or partial doses of the medicine in the form of single tablets or pellets where each unit or partial dose contains from approximately 20 to approximately 2 weight percent of the therapeutic total dose to be administered to the patient on a single occasion.

This procedure allows the dispensing of highly variable doses of a medicine from a single supply of the medicine.

To render this procedure suitable for use by individual patients outside of a hospital environment it is desirable to provide a dosing and dispensing device that is portable and therefore considerably smaller than the dispensing devices typically used within hospitals and pharmacies to store and dispense medicines. It is also desirable to provide a dosing and dispensing device that is easily reusable in the sense that it is efficient, safe and hygienic to refill with units of medicine.

The miniaturization associated with producing a portable dosing and dispensing device has been found to encourage the formation of bridges of tablets within the dosing and dispensing device, which impacts on the efficiency of any such device.

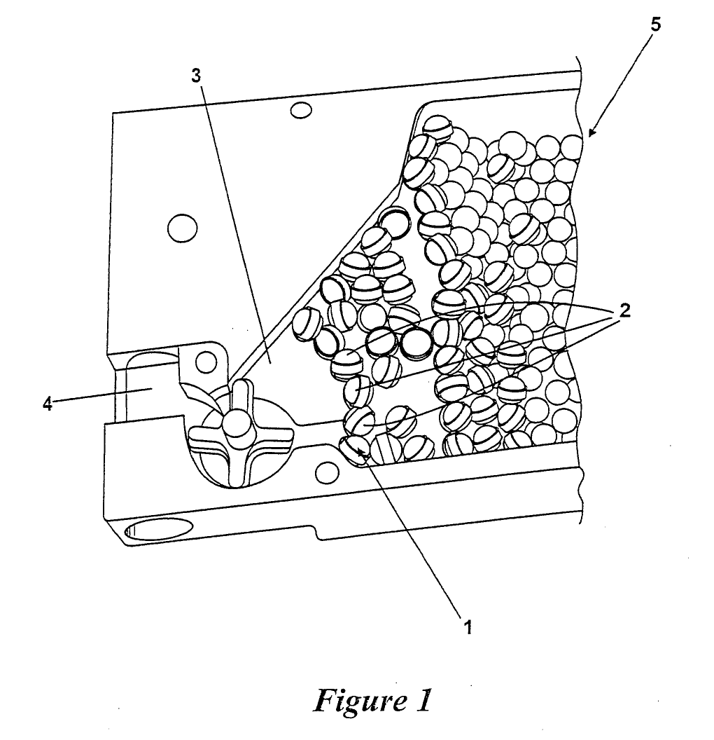

The formation of bridges of tables or pellets within funneled channel sections leading to outlets of tablet dispensing devices is known and is illustrated diagrammatically in FIG. 1, which shows a bridge 1 of tablets 2 formed within a funneled channel 3 leading to an outlet 4 of a storage chamber 5.

EP 0 287 335 discloses a device that seeks to overcome the problems associated with the formation of bridges of tablets in a funneled channel of a tablet dispensing device.

The device disclosed in EP 0 287 335 includes a feed channel having a flexible wall to agitate tablets in the feed channel. However, in order to agitate tablets in the feed channel, the flexible wall must flex both outwardly and inwardly in order to provide the required vibration and therefore necessitates the provision of space in an outward direction into which the wall may flex. The requirement for this outward space results in a larger device than would otherwise be required in order to store the required number of units of medicine.

According to a first aspect of the invention there is provided a hand held medicine dosing and dispensing device comprising a housing including a storage chamber to store discrete units of medicine; a feed assembly located between the storage chamber and a dispenser to feed individual units of medicine from the storage chamber to the dispenser; and an impacter operably associated with the storage chamber to agitate units of medicine stored in the storage chamber, characterised in that the impacter includes a rigid element fixedly connected at or towards one end to a wall of the storage chamber and operably associated at or towards a second end with an actuating mechanism that deflects the second end of the impacter towards the wall of the storage chamber to strain the impacter such that, when released, the strained impacter moves towards the interior of the storage chamber and impacts against the units of medicine.

The provision of an impacter in the form of a rigid element fixedly connected at or towards one end to a wall of the storage chamber results in a means for agitating units of medicine stored within the storage chamber that requires minimal space in an outward direction to operate. It therefore allows the amount of useful storage space within the dosing and dispensing device in percentage terms to be maximized.

To allow for efficient, safe and hygienic refilling of the dosing and dispensing device, the storage chamber is preferably provided in a removable cassette that is releasably engageable within the housing.

This allows the use of cassettes that are refilled within a pharmacy and delivered to a patient in a sealed condition.

In embodiments of the invention in which the storage chamber is provided in a removable cassette, the cassette and the housing preferably include mutually engageable latch members that interengage on insertion of the cassette into the housing to retain the cassette within the housing. In such embodiments, the dosing and dispensing device also preferably includes an ejection mechanism that is selectively operable to disengage the latch members and allow removal of the cassette from the housing.

The provision of an ejection mechanism means the cassette and housing can be formed such that any outer surfaces of the cassette are flush with adjacent outer surfaces of the housing when the cassette is inserted into the housing, which enhances the outer appearance of the dosing and dispensing device.

According to a second aspect of the invention there is provided a hand held medicine dosing and dispensing device comprising a housing including a storage chamber to store discrete units of medicine; and a feed assembly located between the storage chamber and a dispenser to feed individual units of medicine from the storage chamber to the dispenser, wherein the storage chamber is provided in a removable cassette that is releasably engageable within the housing and characterised in that the cassette and the housing include mutually engageable latch members that engage on insertion of the cassette into the housing to retain the cassette within the housing, and the dosing and dispensing device further includes an ejection mechanism that is selectively operable to disengage the latch members and allow removal of the cassette from the housing.

In embodiments where it is important to prevent illegitimate or otherwise unauthorized access to the units of medicine, the ejection mechanism may be adapted so that it is only operable to disengage the latch members and allow removal of the cassette from the housing when the storage chamber of the cassette is empty.

In such an embodiment, the provision of a cassette having outer surfaces that are flush with adjacent outer surfaces of the housing when the cassette is inserted into the housing may reduce the risk of someone being able to force the cassette out of the housing in order to gain unauthorized access to the units of medicine.

To determine whether the storage chamber of a cassette is empty, the dosing and dispensing device preferably includes one or more sensors.

One of the cassette and the housing may include latch members in the form of elongate projections engageable, when the cassette is received within the housing, with latch members in the form of corresponding openings provided in the other of the cassette and the housing. In such embodiments, the dosing and dispensing device preferably includes one or more biasing members to bias each of the elongate projections into engagement with the corresponding opening when the cassette is received within the housing.

Preferably the dispenser includes a dispensing chamber to collect and hold individual units of medicine fed from the storage chamber via the feed assembly, the dispensing chamber including a dispensing outlet selectively openable to dispense units of medicine held in the dispensing chamber.

In order to effect opening of the dispensing outlet, the dispensing chamber may be movable between a first position in which the dispensing outlet is closed and a second position in which the dispensing outlet is open. In such embodiments the dispenser may further include a motor to effect movement of the dispensing chamber between its first and second positions.

It is envisaged that in other embodiments the dispenser may omit the dispensing chamber and the feed assembly may communicate directly with a dispensing outlet.

Regardless of whether or not the storage chamber is provided in a cassette, the feed assembly preferably includes a feed wheel defining a plurality of feed pockets about its circumference. The feed wheel is rotatable in a first direction to move the feed pockets sequentially into alignment with a feed channel of the storage chamber to each receive a unit of medicine. On further rotation of the feed wheel in the first direction, the feed pockets are moved sequentially into alignment with the dispenser so as to feed the received units of medicine sequentially to the dispenser.

In embodiments where the storage chamber is provided in the form of a cassette, the feed wheel is preferably located in the cassette. Such an arrangement results in the provision of a sealed feed assembly and therefore minimizes the risk of the introduction of contaminants into the feed assembly during replacement of the cassette, for example.

The dispenser may also form part of the cassette, the feed wheel being located between the storage chamber and the dispenser, and thereby also minimizing the risk of the introduction of contaminants into the dispenser during replacement of the cassette.

The dosing and dispensing device preferably includes a motor to drive the feed wheel, the drive motor preferably being controllable to drive the feed wheel to rotate in the first direction so as to feed a predetermined number of units to the dispenser.

Where the storage chamber is provided in a cassette and an ejection mechanism is provided to eject the cassette from the housing, the drive motor also preferably forms part of the ejection mechanism and is controllable to drive the feed wheel to rotate in a second direction to disengage the latch members and allow removal of the cassette from the housing.

In such embodiments, the feed wheel may include a drive shaft and the drive motor may include a drive gear engageable with an end of the drive shaft. The end of the drive shaft defines a pair of sloped contact surfaces, each contact surface terminating in a shoulder against which the drive gear engages on rotation in a first direction and the sloped contact surfaces defining cam surfaces along which the drive gear travels causing movement of the cassette relative to the housing on rotation of the drive motor in the second direction to disengage the latch members.

The dosing and dispensing device may further include a biasing member to expel the cassette on disengagement of the latch members.

In preferred embodiments, the feed wheel defines the actuating mechanism and the impacter is operably associated at or towards its second end with the feed wheel.

In order to effect deflection of the impacter, the feed wheel may include a plurality of equidistantly spaced fins protruding outwards from its outer circumference, adjacent fins defining the feed pockets therebetween. Rotation of the feed wheel in the first direction moves each of the fins sequentially into engagement with a front face of the second end of the impacter. Continued rotation of the feed wheel causes deflection of the second end of the impacter towards the wall of the storage chamber as the respective fin is moved across the front face of the second end of the impacter and out of engagement therewith.

This arrangement effects the movement required to cause repeated agitation of the units of medicine stored in the storage chamber during dispensing of a number of units of medicine and therefore assists in ensuring that units of medicine stored in the storage chamber do not form a bridge during dispensing. It therefore assists in improving the efficiency of the dosing and dispensing device.

In embodiments where the storage chamber is provided in a removable cassette and the feed wheel is located in the cassette, rotation of the feed wheel in the second direction preferably moves an adjacent one of the fins into engagement with a second face of the second end of the impacter such that the second end of the impacter blocks further rotation of the feed wheel in the second direction.

In other embodiments, the impacter may be formed from a magnetic material and the actuating mechanism may include an electro-magnet selective operable to cause deflection of the second end of the impacter towards the wall of the storage chamber.

The dosing and dispensing device preferably includes a controller to control operation of the dosing and dispensing device, and such controller preferably being programmable to prompt a user to activate the dosing and dispensing device to dispense a predetermined number of units of medicine at one or more predetermined times.

The dosing and dispensing device may includes a display to display information to a user, which allows the dosing and dispensing device to display, for example, time, medication and/or dosage size.

The dosing and dispensing device also preferably includes a data input device to enter data into the controller and effect operation of the dosing and dispensing device in accordance with the input data.

The provision of a data input device allows a user to influence operation of the dosing and dispensing device in dependence on the user's symptoms, for example.

Preferably the display and the data input device are provided in the form of a touch-sensitive screen.

In such embodiments a visual analogue scale (VAS) may be selectively displayed on the screen to facilitate the input of data, and the visual analogue scale (VAS) may be displayed on the screen when the dosing and dispensing device dispenses one or more units of medicine.

In particularly preferred embodiments, the dosing and dispensing device includes a memory to store times of dosing and dose sizes provided and thereby maintain an electronic log function. This in turn can be used to monitor dosage compliance. In such embodiments the dosing and dispensing device may not necessarily require the provision of an input device.

The dosing and dispensing device may include a settable alarm that emits sound or light, and/or causes the dispensing device to vibrate at one or more predetermined times. This helps to ensure that the user dispenses the required number of units of medicine and takes his or her dose of the medicine within the therapeutic window associated with the medicine.

In order to prevent illegitimate or otherwise unauthorized dosing and dispensing of units of medicine, the dosing and dispensing device may include a lock. This reduces the risk of children, for example, dosing and dispensing units of medicine from the dispensing device.

In embodiments where the storage chamber is provided in the form of a cassette, the cassette may include a readable marker and a controller in the device may include a reader to read the marker on the cassette and thereby allow the controller to identify the medicine contained in the cassette.

This arrangement permits the controller to be pre-programmed to function in a number of predetermined modes of operation, each mode of operation being specific to a particular medicine, and to then select the mode of operation applicable to the medicine contained in the cassette once it has identified the medicine contained in the cassette.

A preferred embodiment of the invention will now be described, by way of a non-limiting example, with reference to the accompanying figures in which:

FIG. 1 illustrates the formation of a bridge of tablets within a funneled channel section;

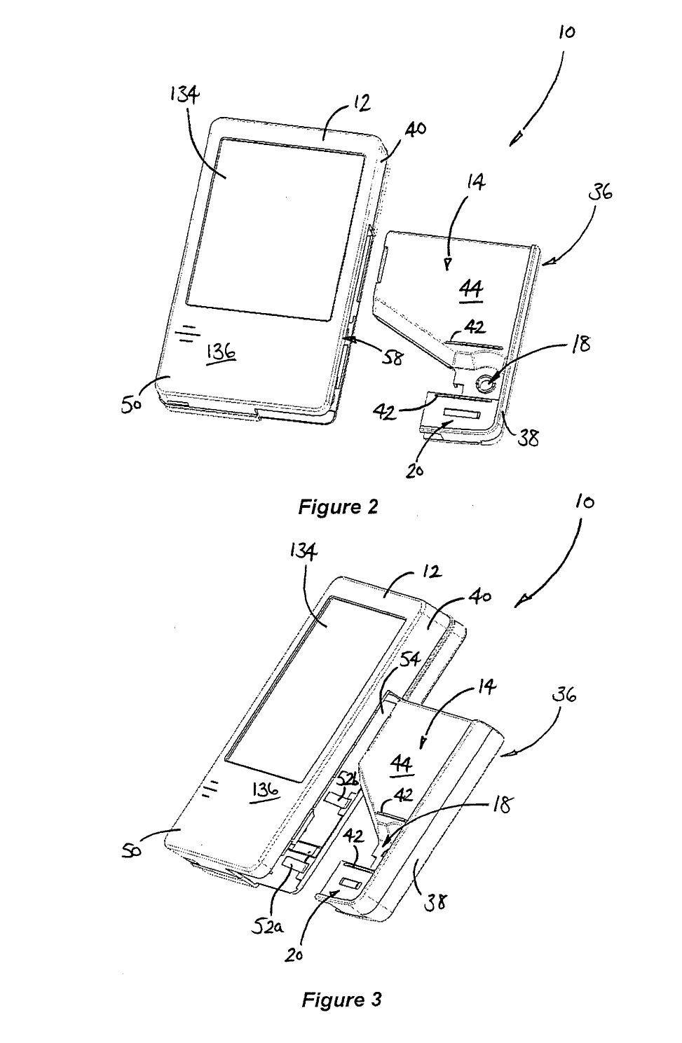

FIGS. 2 and 3 show a hand held medicine dosing and dispensing device according to an embodiment of the invention;

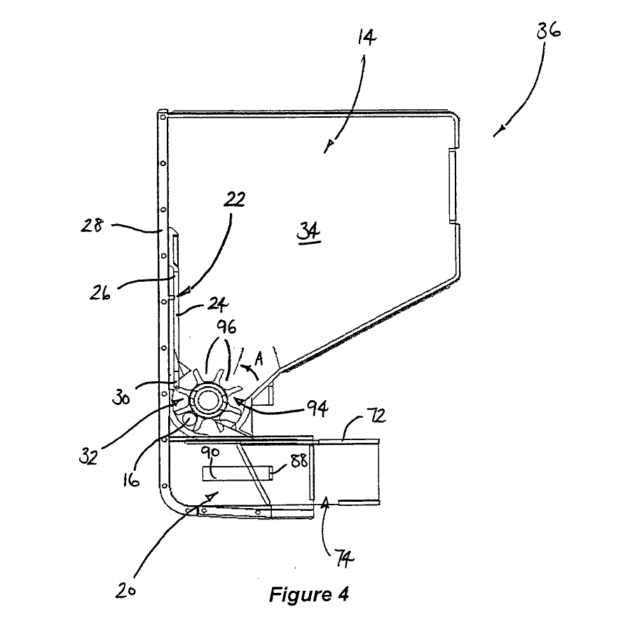

FIG. 4 shows a cross-sectional view of a cassette of the hand held medicine dosing and dispensing device of FIGS. 2 and 3;

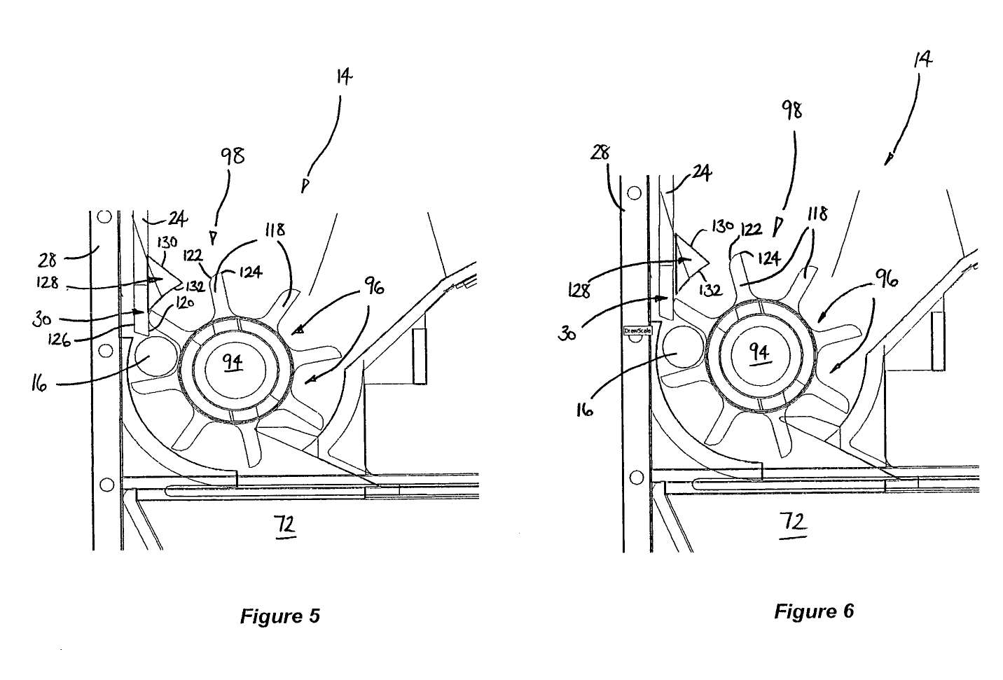

FIGS. 5 to 8 illustrate operation of an impacter of the hand held medicine dosing and dispensing device of FIGS. 2 and 3;

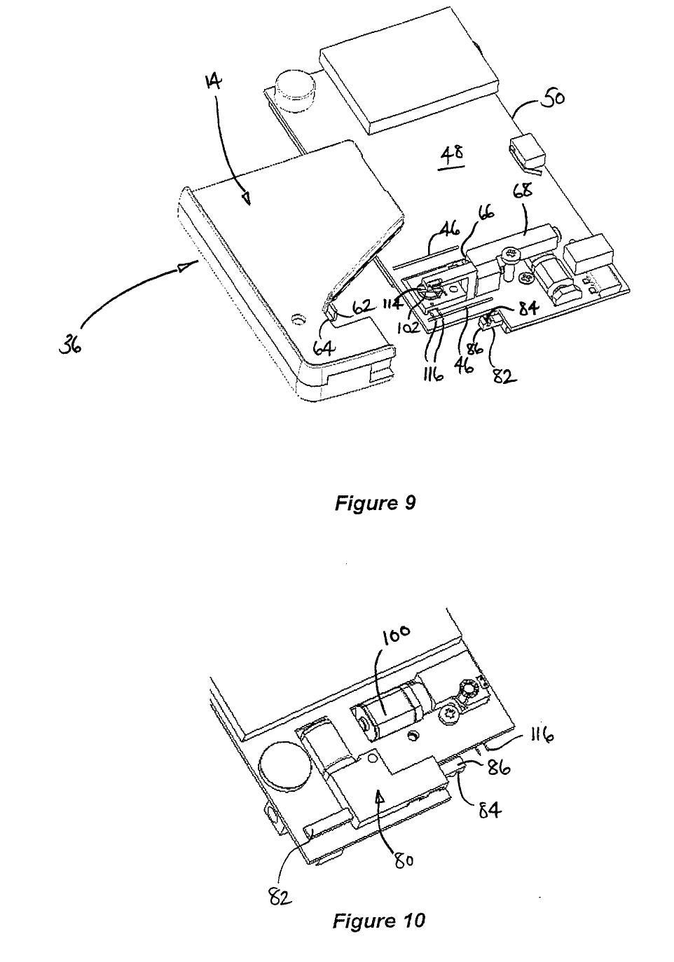

FIGS. 9 and 10 show internal controls of the hand held medicine dosing and dispensing device of FIGS. 2 and 3;

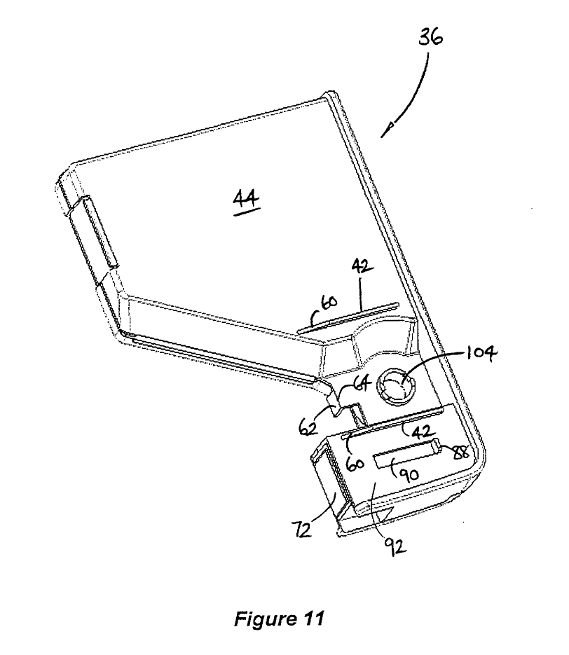

FIG. 11 shows a rear face of the cassette of FIG. 4;

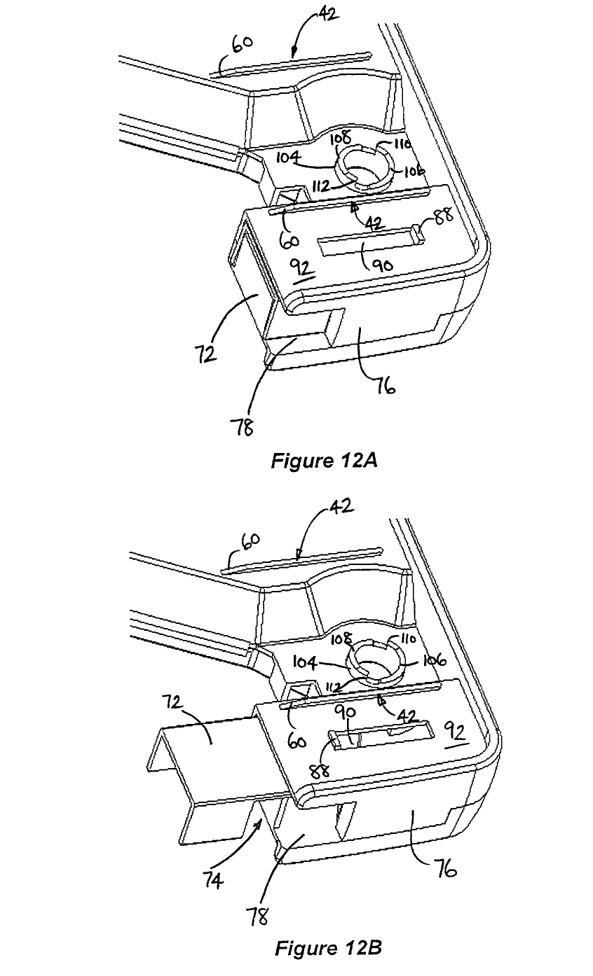

FIGS. 12A and 12B illustrate operation of a dispensing chamber of a dispenser of the cassette of FIG. 4; and

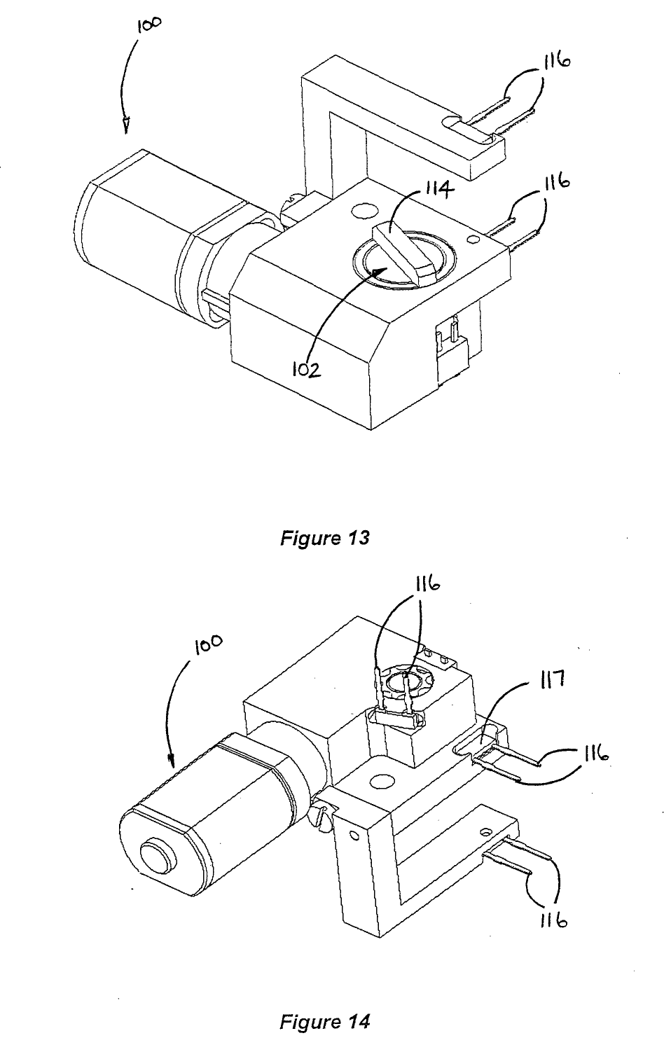

FIGS. 13 and 14 show front and rear perspective views of a drive motor of the hand held dosing and dispensing device of FIGS. 2 and 3.

A hand held medicine dosing and dispensing device 10 according to an embodiment of the invention is shown in FIGS. 2 and 3.

The dosing and dispensing device 10 is comparable in size with other hand held devices such as, for example, mobile telephones, thereby rendering the dosing and dispensing device 10 suitable for use as a hand held device. It is envisaged that in other embodiments the size and shape of the dosing and dispensing device 10 may be varied to render the dosing and dispensing device 10 suitable for users having limited dexterity, for example.

The dosing and dispensing device 10 includes a housing 12 including a storage chamber 14 to store discrete units of medicine 16 and a feed assembly 18 located between the storage chamber 14 and a dispenser 20. The dosing and dispensing device 10 also includes an impacter 22 (FIG. 4) that is operably associated with the storage chamber 14 to agitate units of medicine 16 stored in the storage chamber 14.

As can be seen from FIG. 4, the impacter 22 includes a rigid element 24 fixedly connected at one end 26 to a wall 28 of the storage chamber 14. The impacter 22 is operably associated at a second end 30 with an actuating mechanism 32 that deflects the second end 30 of the impacter 22 towards the wall 28 of the storage chamber 14 to strain the impacter 22 such that, when released, the strained impacter 22 moves towards the interior 34 of the storage chamber 14 and impacts again units of medicine 16 stored therein.

In the embodiment shown in FIGS. 2 and 3, the dosing and dispensing device 10 includes a storage chamber 14 provided in a removable cassette 36 that is releasably engageable with the housing 12.

In other embodiments of the invention it is envisaged that the storage chamber 14 may be permanently located within the housing 12, the housing 12 including an opening to permit access to the storage chamber 14 to permit refilling thereof.

The housing 12 and cassette 36 include mutually engageable latch members that interengage on insertion of the cassette 36 into the housing 12 to retain the cassette 36 within the housing 12. The dosing and dispensing device 10 also includes an ejection mechanism that is selectively operable to disengage the latch members and allow removal of the cassette 36 from the housing 12.

This allows the provision of a cassette 36 that, when received in the housing 12, has an external surface 38 that sits flush with an adjacent outer surface 40 of the housing 12, which enhances the appearance of the dosing and dispensing device 10.

The latch members include elongate projections 42 provided on an upper face 44 of the cassette 36 and extending in the direction in which the cassette 36 is inserted into and withdrawn from the housing 12.

The latch members also include correspondingly shaped and sized openings 46 (FIGS. 9 and 10) provided on an inner surface 48 of an upper face 50 of the housing 12. The openings 46 are located on the inner surface 48 so as to be aligned with the projections 42 provided on the cassette 36. Accordingly, when the cassette 36 is fully inserted into the housing 12, the elongate projections 42 are received within the respective openings 46. This engagement prevents sliding withdrawal of the cassette 36 from the housing 12.

In the embodiment shown in FIGS. 2 and 3, first and second leaf springs 52a,52b are provided on an inner surface 54 of the lower face 56 of the housing 12. The first and second leaf springs 52a,52b are located within an internal cavity 58 of the housing 12 in which the cassette 36 is received and act on the cassette 36 to bias the cassette 36 towards the inner surface 48 of the upper face 50 of the housing 12. The leaf springs 52a,52b thereby bias the projections 42 into engagement with the respective openings 46.

On insertion of the cassette 36 into the internal cavity 58 of the housing 12, a leading end face 60 of each of the projections 42 contacts the inner surface 54 of the lower face 56 of the housing 12. To assist sliding movement of this leading end 60 over the inner surface 54, the leading end 60 of each projection 42 is beveled as shown in FIGS. 11 and 12.

On continued sliding movement of the cassette 36 into the internal cavity 58, the leading end 60 engages the respective opening 46 in the inner surface 48 of the upper face 50 of the housing 12, this engagement serving to guide and locate the remainder of the projection 42 into the respective opening 46. Consequently, as well as acting to retain the cassette 36 within the housing 12, engagement of the projections 42 in the openings 46 during insertion of the cassette 36 into the housing 12 acts to guide and locate the cassette 36 in the internal cavity 58 of the housing 12.

On insertion of the cassette 36 into the internal cavity 58, a spring support 62 (FIG. 9) provided on an end wall 64 of the cassette 36 engages against an engagement surface 66 of a biasing member 68, which is moveably mounted on the inner surface 48 of the upper face 50 of the housing 12.

Engagement of the spring support 62 against the engagement surface 66, on insertion of the cassette 36 into the internal cavity 58, causes displacement of the biasing member 68 towards an opposed wall (not shown) of the housing 12. This in turn causes engagement of an opposite side of the engagement surface 66 against a coiled spring (not shown) located within the biasing member 68. The coiled spring is fixed at an end remote from the engagement surface 66 such that displacement of the biasing member 68 towards the opposed wall causes compression of the coiled spring such that the coiled spring acts on the engagement surface 66 so as to bias the biasing member 68 away from the opposed wall. As a result the biasing member 68 biases the cassette 36 in an outward direction relative to the internal cavity 58 of the housing 12.

The biasing force provided by the coiled spring located within the biasing member 68 may be adjusted by adjusting the degree of compression present within the coiled spring prior to engagement of the spring support 62 against the engagement surface 66. The greater the degree of compression present in the coiled spring prior to such engagement the greater the biasing force provided on engagement of the spring support 62 against the engagement surface 66, and vice versa. This is advantageous in that it allows adjustment of the force applied to the cassette 36 during ejection of the cassette 36 from the housing 12, which is described below.

Engagement of the projections 42 within the openings 46 retains the cassette 36 within the internal cavity 58 of the housing 12 against the bias provided by the compression spring via the biasing member 68.

In the embodiment shown in FIGS. 2 and 3, the dispenser 20 includes a dispensing chamber 72 (FIGS. 12A and 12B) to collect and hold individual units of medicine 16 from the storage chamber 14 via the feed assembly 18. The dispensing chamber 72 includes a dispensing outlet 74 that is selectively openable to dispense units of medicine 16 held in the dispensing chamber 72.

The dispenser 20 forms part of the cassette 36 and the dispensing chamber 72 is movable between a first position (FIG. 12A) in which the dispensing outlet 74 is closed and a second position (FIG. 12B) in which the dispensing outlet 74 is open.

In the first position of the dispensing chamber 72 the dispensing outlet 74 is aligned with a base wall 76 of the cassette 36, the base wall 76 thereby closing the dispensing outlet 74.

In the second position of the dispensing chamber 72 the dispensing outlet 74 is aligned with an opening 78 provided in the base wall 76 of the cassette 36, the opening 78 thereby opening the dispensing outlet 74.

Movement of the dispensing chamber 72 between its first and second positions is effected by means of a first drive motor 80 (FIG. 10) that is operable to drive linear movement of a drive member 82 (FIGS. 9 and 10) in first and second directions. The drive member 82 defines a recess 84 at a free end 86 to receive a peg 88 protruding from the dispensing chamber 72 through a slot 90 provided in a side wall 92 of the cassette 36. Through engagement of the drive member 82 with the peg 88, movement of the drive member 82 causes movement of the peg 88 from one end of the slot 90 to the other and back, and thereby results in movement of the dispensing chamber 72 from its first position to its second position and back to its first position.

In other embodiments it is envisaged that the dispenser 20 may not include a dispensing chamber 72, and the feed assembly 18 may feed the units of medicine 16 direct to a permanently open dispensing outlet 74 of the dispenser 20.

The feed assembly 18 includes a feed wheel 94 (FIG. 4) defining a plurality of feed pockets 96 about its circumference. In the embodiment shown in FIGS. 2 and 3 the feed wheel 94 is located in the cassette 36 between the storage chamber 14 and the dispenser 20.

The feed wheel 94 is mounted to rotate so that rotation in a first direction, which is depicted by arrow A in FIG. 4, moves the feed pockets 96 sequentially into alignment with a feed channel 98 of the storage chamber 14 to each receive a unit of medicine 16.

On further rotation of the feed wheel 94 in the first direction, the feed pockets 96 are moved sequentially into alignment with an inlet of the dispensing chamber 72 of the dispenser 20 to feed the respective units of medicine 16 into the dispensing chamber 72 dispenser 20.

The dosing and dispensing device 10 includes a second drive motor 100 (FIGS. 9, 10, 13 and 14) to drive the feed wheel 94 to rotate, the second drive motor 100 being mounted on the inner surface 48 of the upper face 50 of the housing 12.

On insertion of the cassette 36 into the internal cavity 58 of the housing 12, a drive gear 102 (FIG. 13) engages a drive shaft 104 (FIGS. 11, 12A and 12B) that protrudes from the upper face 44 of the cassette 36.

The drive shaft 104 is formed to define sloped edges 106,108 that terminate in shoulders 110,112 (FIGS. 12A and 12B).

The drive gear 102 includes an elongate lug 114 that engages the shoulders 110,112 and, on rotation of the second drive motor 100 in a first direction, drives the drive shaft 104 to rotate. This in turn causes the feed wheel 94 to rotate in the first direction.

As can be seen from FIGS. 9, 10, 13 and 14, the second drive motor 100 includes electrical contacts 116. These electrical contacts 116 engage corresponding contacts (not shown) on the cassette 36 on insertion of the cassette 36 into the internal cavity 58 of the housing 12.

In the embodiment shown in FIGS. 2 and 3, the drive shaft 104 is operable by hand to effect rotation of the feed wheel 94 in the first direction when the cassette 36 is removed from the housing. Such operation allows a user to feed units of medicine 16 from the storage chamber 14 of the cassette 36 in the event, for example, that a fault occurs within the dosing and dispensing device 10 that prevents a user from operating the dosing and dispensing device 10 to prepare and dispense a dose of the medicine contained within the storage chamber 14.

In other embodiments, where it is desirable to prevent unauthorized or illegitimate access to the units of medicine 16, the drive shaft 104 may be locked against manual rotation so that units of medicine 16 may only be accessed when the cassette 36 is mounted within the housing 12 of the dosing and dispensing device 10. In such embodiments the cassette 36 may also be sealed so as to prevent unauthorized access to any units of medicine 16 stored in the storage chamber 14 of the cassette 36.

The dosing and dispensing device 10 also includes a sensor in the form of a photocell 117 (FIG. 14) arranged relative to the inlet of the dispensing chamber 72 to detect movement of units of medicine 16 from feed pockets 96 of the feed wheel 94 into the dispensing chamber 72.

The sensor monitors the movement of units of medicine 16 moving from the feed pockets 96 of the feed wheel 94 into the dispensing chamber 72. The information provided by the sensor allows movement of the second drive motor 100 to be controlled to drive the feed wheel 94 in the first direction so as to feed a predetermined number of units of medicine 16 to the dispenser 20.

The sensor also allows the dosing and dispensing device 10 to determine when the storage chamber 14 is empty.

More specifically, in use, the second drive motor 100 drives the feed wheel 94 to rotate so as to feed units of medicine 16 from the storage chamber 14 of the cassette 36, via the feed pockets 96, to the dispensing chamber 72.

During this movement, the photocell 117 is located relative to the inlet of the dispensing chamber 72 so as to enable the dosing and dispensing device 10 to be able to determine the number of units of medicine 16 that are fed into the dispensing chamber 72.

The second drive motor 100 is controlled to continue to drive rotation of the feed wheel 94 until the dosing and dispensing device 10 determines via the photocell 117 that the required number of units of medicine 16 have been fed into the dispensing chamber 72, at which point the second drive motor 100 stops driving rotation of the feed wheel 94.

This arrangement means that the feed wheel 94 continues to turn to deliver units of medicine 16 into the dispensing chamber 72 until the required number of units of medicine 16 is fed into the dispensing chamber 72. It thereby ensures that the required number of units of medicine 16 is fed into the dispensing chamber 72 regardless of whether or not one of the feed pockets 96 fails to receive and feed a unit of medicine 16 from the storage chamber 14 to the dispensing chamber 72 during rotation of the feed wheel 94.

If the photocell 117 identifies a number of consecutive empty feed pockets 96 exceeding a predetermined number during rotation of the feed wheel 94, the dosing and dispensing device 10 determines that the storage chamber 14 is empty.

Preferably the dosing and dispensing device 10 determines that the storage chamber 14 is empty if the photocell 117 identifies more than six consecutive empty feed pockets 96 being aligned with the inlet of the dispensing chamber 72 during rotation of the feed wheel 94.

In other embodiments, depending on the nature of the units of medicine 16, and the ease with which the units of medicine 16 move from the storage chamber 14 into the feed pockets 96, the predetermined number of consecutive empty feed pockets required to determine whether the storage chamber 14 is empty may increase or decrease.

In order to eject the cassette 36 once the storage chamber 14 is empty, or early if the patient wishes to replace the cassette 36 with a cassette 36 containing a different medicine or to gain direct access to the units of medicine contained within the cassette 36, the second drive motor 100 may be driven in a second, opposite, direction.

Rotation of the second drive motor 100 in the opposite direction causes the lug 114 to travel along the sloped edges 106,108 on the drive shaft 104. Since the drive gear 102 is fixe d relative to the upper face 50 of the housing 12, movement of the lug 114 along the sloped edges 106,108 causes movement of the cassette 36 away from the inner surface 48 of the upper face 50 of the housing 12. This movement in turn moves the projections 42 out of engagement with the openings 46 and the bias provided by the compressed spring located within the biasing member 68 pushes the cassette 36 in an outward direction and thereby ejects the cassette 36 from the housing 12.

Once the cassette 36 is ejected, a user may insert a replacement cassette 36 into the dosing and dispensing device 10 in order to replenish or change the supply of medicine contained within the dosing and dispensing device 10.

In other embodiments it is envisaged that the second drive motor 100 may only be driven in the second, opposite, direction once the sensors have determined that the storage chamber 14 of the cassette 36 is empty. In such embodiments, controlled operation of the ejection mechanism prevents unauthorized or otherwise illegitimate access to the units of medicine 16 stored within the storage chamber 14 of the cassette 36.

In such embodiments the provision of an external surface 38 of the cassette 36 that is flush with the adjacent outer surface 40 of the housing 12 is advantageous in that it reduces the possibility of someone seeking to prise the cassette 36 out of the housing 12.

In the embodiment shown in FIGS. 2 and 3, the feed wheel 94 defines the actuating mechanism 32 with which the second end 30 of the impacter 22 is operably associated.

In particular, the feed wheel 94 includes a plurality of equidistantly spaced fins 118 protruding outwardly from its outer circumference, adjacent fins 118 defining the feed pockets 96 therebetween.

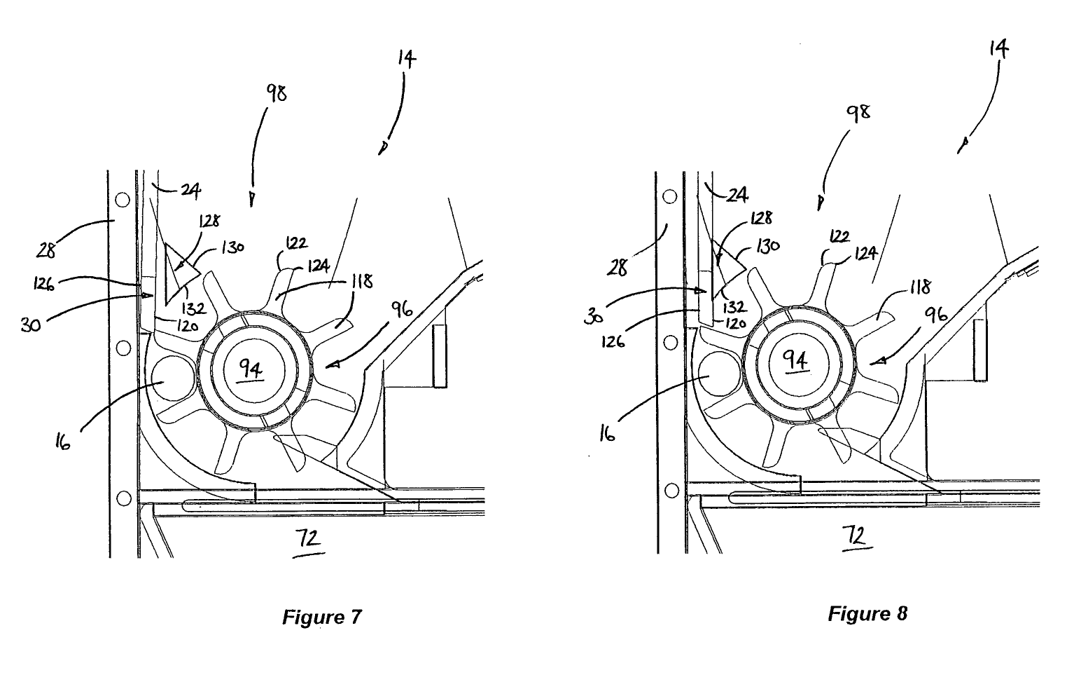

The length of each of the fins 118 is such that rotation of the feed wheel 94 in the first direction moves each of the fins 118 sequentially into engagement with a front face 120 of the second end 30 of the impacter 22, as shown in FIG. 5. Continued rotation of the feed wheel 94 causes deflection of the second end 30 of the impacter 22 towards the wall 28 of the storage chamber 14 as the respective fin 118 is moved across the front face 120 (FIGS. 6 and 7) until the fin 118 moves out of engagement with the second end 30 of the impacter 22 (FIG. 8).

Once the respective fin 118 moves out of engagement with the front face 120 of the second end 30 of the impacter 22, the strained impacter 22 moves towards the interior 34 of the storage chamber 14 and impacts against units of medicine 16 stored therein.

The free end of each fin 118 that contacts the second end 30 of the impacter 22 is shaped so as to present a curved face 122 to the front face 120 of the second end 30 of the impacter 22 so as to facilitate movement over the front face 120.

The curved face 122 terminates in a shoulder 124 that is brought into engagement with a rear face 126 of the second end 30 of the impacter 22 in the event the feed wheel 94 is driven to rotate in a second, opposite, direction. This engagement together with the relative positions of the second end 30 of the impacter 22 and the free end of the fin 118 when the impacter 22 is in its unstrained condition means that the second end 30 of the impacter 22 blocks further rotation of the feed wheel 94 in the second direction.

In other embodiments of the invention it is envisaged that movement of the second end 30 of the impacter 22 towards the wall 28 of the storage chamber 14 may be effected by other means.

In one other such embodiment the impacter 22, or at least the second end 30 of the impacter 22, is formed from, or coated with, a magnetic material and an electro-magnet is provided in the storage chamber 14.

On the application of a current to the electro-magnet, the magnetic field produced by the electro-magnet causes deflection of the second end 30 of the impacter 22 towards the wall 28 of the storage chamber 14 so as to strain the impacter 22.

In such an embodiment, the electro-magnet may be mounted on the wall 28 of the storage chamber 14 and the magnetic field produced by the electro-magnet may attract the second end 30 of the impacter 22 towards the wall 28 of the storage chamber 14.

The second end 30 of the impacter 22 is released, allowing the strained impacter 22 to move towards the interior 34 of the storage chamber 14, on removal of the current to the electro-magnet.

As can be seen from FIGS. 5 to 8, the dosing and dispensing device 10 includes a separating element 128 located above the feed wheel 94 and adjacent the impacter 22 so as to prevent units of medicine 16 becoming jammed between a feed pocket 96 in the feed wheel 94 already containing a unit of medicine 16 and the impacter 22. The separating element 128 presents a sloped face 130 towards the interior 34 of the storage chamber 14 so as to direct the units of medicine towards the feed channel 98 of the storage chamber 14. The separating element 128 also presents a curved face 132 to the feed wheel 94 so as to allow the tips of the fins 118 to travel past the separating element 128.

The dosing and dispensing device 10 shown in FIGS. 2 and 3 includes a programmable controller to prompt a user to dispense units of medicine 16 at one or more pre-determined times throughout the day.

At the or each predetermined time, the controller activates an alarm provided in the dosing and dispensing device 10 to emit sound or light and/or causes the dosing and dispensing device 10 to vibrate so as to alert the user to dispense units of medicine 16 and take his or her dose of the medicine within a therapeutic window associated with the medicine.

In the event the user does not respond to an initial alarm, the controller may be programmed to emit one or more further alarms within a predetermined time from the first alarm.

When the user is alerted to the need to dispense units of medicine 16, a message delivered on a display 134 provided on an outer surface 136 of the upper face 50 of the housing 12 prompts the user to enter a code into the dosing and dispensing device 10 via a data input device.

In the embodiment shown in FIGS. 2 and 3, the display 134 is provided in the form of a touch-sensitive screen, which also functions as the data input device.

On entry of the correct code, the dosing and dispensing device 10 is unlocked and a message delivered on the display 134 prompts the user to activate the dosing and dispensing device 10 to feed either a predetermined number of units of medicine 16 into the dispensing chamber 72 or prompts the user to identify the dose of medicine he or she requires.

In other embodiments it is envisaged that the data input device may be provided in the form of a keypad mounted on the outer surface 136 of the upper face 50 of the housing 12.

It is also envisaged that in other embodiments the lock may be omitted.

Following the required response from the user, the controller operates the second drive motor 100 to operate the feed wheel 94 to feed the number of units of medicine 16 into the dispensing chamber 72 that will provide the required dose of medicine to the user.

During operation of the feed wheel 94 to feed units of medicine 16 into the dispensing chamber 72, a sensor, preferably provided in the form of a photocell, senses the movement of each unit of medicine 16 that passes from the feed wheel 94 into the dispensing chamber 72. This allows the controller to count the number of units of medicine 16 that are fed into the dispensing chamber 72.

Once the sensor has counted the required number of units of medicine 16 being fed into the dispensing chamber 72, the controller ceases operation of the second drive motor 100 and thereby ceases operation of the feed wheel 94.

The first motor 80 is then operated to cause movement of the dispensing chamber 72 from its first position to its second position so as to open the dispensing outlet 74 of the dispenser 20 and dispense the dose of medicine held in the dispensing chamber 72 to the user.

In other embodiments, it is envisaged that the dosing and dispensing device 10 will automatically feed a predetermined number of units of medicine 16 to the dispensing chamber 72 once the dosing and dispensing device 10 is unlocked.

The controller may display further messages before, during or after operation of the second drive motor 100 to prompt the user to respond to questions concerning the nature of any symptoms he or she may be experiencing via the data input device.

In the embodiment shown in FIGS. 2 and 3, where the display 134 is a touch-sensitive screen, responses to these questions may be input via a visual analogue scale (VAS) displayed on the display 134. This allows a user to provided information concerning pain levels, for example, via the use of a straight line scale extending from zero, meaning no pain, to ten, meaning intolerable pain.

The information provided by the patient to the questions posed, via the data input device, is stored within a memory provided in the dosing and dispensing device 10 and may be accessed on the display 134 of the dosing and dispensing device 10 or by connecting the dosing and dispensing device 10 to a computer via a USB port, for example.

This facility allows a user and his or her physician to monitor the user's symptoms at the time of drug intake, for example, which may be particularly beneficial for the user and the physical in the dose-finding process.

As well as storing data input by the user, the memory provided in the dosing and dispensing device 10 may record the times at which the dosing and dispensing device 10 is activated to prepare a dose of medicine and dispense that dose. It may also record the dose prepared and dispensed each time in terms of the number of units of medicine 16. This information provides an electronic log, which may be accessed by connecting the dosing and dispensing device 10 to a computer, and provides a means for monitoring dosage compliance.

In embodiments not shown in the figures, the cassette 36 includes a readable marker (not shown) identifying the medicine contained within the storage chamber 14 of the cassette 36. A reader provided within the inner cavity 58 of the housing 12 of the dosing and dispensing device 10 reads the readable marker is read on insertion of the cassette 36 into the inner cavity 58, and allows the controller within the dosing and dispensing device 10 to identify the medicine.

In such embodiments, the controller may be programmed to function in a number of predetermined modes of operation, each mode of operation being specific to a particular medicine, and to then select the mode of operation applicable to the medicine contained in the cassette 36 once it has identified the medicine contained in the cassette 36.

The provision of a readable marker is advantageous in circumstances where there are insufficient units of medicine contained within a cassette to allow the dosing and dispensing device 10 to feed the required number of units of medicine 16 to the dispensing chamber 72 in a single operation. In such circumstances the dispensing outlet 74 of the dispenser 20 may be opened to dispense the units of medicine 16 held in the dispensing chamber 72 and the empty cassette 36 is replaced with a replacement cassette 36. The controller may check that the replacement cassette 36 contains the same medicine before operating the second drive motor 100 to continue to feed the units of medicine 16 to the dispensing chamber 72 required to complete the dose. Preferably in such circumstances the display 134 displays a message to the user clearly identifying that the units of medicine 16 dispensed from the dispensing chamber 72 prior to replacement of the empty cassette 36 is an incomplete dose.

In other embodiments it is envisaged that the dispenser 20 forms part of the housing 12 instead of the cassette 36. In such embodiments the location of the dispensing chamber 72 in the housing 12 renders it unnecessary for an incomplete dose to be dispensed prior to replacement of an empty cassette 36.

The number of units of medicine 16 to be dispensed from the dosing and dispensing device 10 is determined by the size of the total dose required and is therefore determined by the amount of active ingredient or medicine contained in each unit of medicine 16.

The amount of active ingredient contained in each unit of medicine 16 may be chosen depending on the nature of the medicine and the side effects that arise from over or under dosing. For example, the amount of active ingredient contained in each unit of a medicine for which the side effects arising from over or under dosing are minimal may be greater than that for a medicine for which the side effects are more pronounced. This is because the greater the amount of active ingredient contained in each unit of medicine, the less possible it is to fine tune the total dose.

Consideration must also however be made of the consequences of having to store in the storage chamber 14 a relatively large number of partial doses in the form of individual units of medicine in the event each unit of medicine contains a very low amount of active ingredient.

Preferably therefore each unit of medicine contains from approximately 20% to 2% of the weight of the total dose to be administered and dispensed from the dosing and dispensing device 10 at any one time.

The units of medicine may be provided in the form of tablets or pellets, and preferably have convex or iso-diametrical surfaces so as to define a spherical or near spherical shape produced through the use of a punch having a concave surface.

In circumstances where the units of medicine are provided in the form of tablets, the tablets preferably have a diameter in the range of 1-13 mm, more preferably in the range of 2-8 mm and most preferably in the range of 2-5 mm.

In circumstances where the units of medicine are provided in the form of pellets, the pellets preferably have a size in the range of 1-8 mm and most preferably in the range of 1-4 mm.

1. A hand held medicine dosing and dispensing device comprising a housing including a storage chamber to store discrete units of medicine; a feed assembly located between the storage chamber and a dispenser to feed individual units of medicine from the storage chamber to the dispenser; and an impacter operably associated with the storage chamber to agitate units of medicine stored in the storage chamber, wherein the impacter includes a rigid element fixedly connected at or towards one end to a wall of the storage chamber and operably associated at or towards a second end with an actuating mechanism that deflects the second end of the impacter towards the wall of the storage chamber to strain the impacter such that, when released, the strained impacter moves towards the interior of the storage chamber and impacts against the units of medicine.

2-3. (canceled)

4. A hand held medicine dosing and dispensing device comprising a housing including a storage chamber to store discrete units of medicine; and a feed assembly located between the storage chamber and a dispenser to feed individual units of medicine from the storage chamber to the dispenser, wherein the storage chamber is provided in a removable cassette that is releasably engageable within the housing and characterised in that the cassette and the housing include mutually engageable latch members that interengage on insertion of the cassette into the housing to retain the cassette within the housing, and the dosing and dispensing device further includes an ejection mechanism that is selectively operable to disengage the latch members and allow removal of the cassette from the housing.

5. A hand held medicine dosing and dispensing device according to claim 4 wherein the ejection mechanism is only operable to disengage the latch members and allow removal of the cassette from the housing when the storage chamber of the cassette is empty.

6. A hand held medicine dosing and dispensing device according to claim 5 wherein the dosing and dispensing device further includes one or more sensors to determine when the storage chamber is empty.

7. A hand held medicine dosing and dispensing device according to claim 4 wherein one of the cassette and the housing includes latch members in the form of elongate projections engageable, when the cassette is received within the housing, with latch members in the form of corresponding openings provided in the other of the cassette and the housing, and the dosing and dispensing device further includes one or more biasing members to bias each of the elongate projections into engagement with the corresponding opening when the cassette is received within the housing.

8. A hand held medicine dosing and dispensing device according to claim 4 wherein the dispenser includes a dispensing chamber to collect and hold individual units of medicine fed from the storage chamber via the feed assembly, the dispensing chamber including a dispensing outlet selectively openable to dispense units of medicine held in the dispensing chamber.

9. A hand held medicine dosing and dispensing device according to claim 8 wherein the dispensing chamber is selectively movable between a first position in which the dispensing outlet is closed and a second position in which the dispensing outlet is open.

10. A hand held medicine dosing and dispensing device according to claim 9 wherein the dispenser further includes a motor to effect movement of the dispensing chamber between its first and second positions.

11. A hand held medicine dosing and dispensing device according to claim 4 wherein the feed assembly includes a feed wheel defining a plurality of feed pockets about its circumference, the feed wheel being rotatable in a first direction to move the feed pockets sequentially into alignment with a feed channel of the storage chamber to each receive a unit of medicine and, on further rotation of the feed wheel in the first direction, to move the feed pockets sequentially into alignment with the dispenser so as to feed the received units of medicine sequentially to the dispenser.

12. A hand held medicine dosing and dispensing device according to claim 4, wherein the feed wheel is located in the cassette.

13. A hand held medicine dosing and dispensing device according to claim 8, wherein the dispenser forms part of the cassette and the feed wheel is located in the cassette between the storage chamber and the dispenser.

14. A hand held medicine dosing and dispensing device according to claim 11 wherein the dosing and dispensing device includes a drive motor to drive the feed wheel to rotate.

15. A hand held medicine dosing and dispensing device according to claim 14 wherein the drive motor is controllable to drive the feed wheel to rotate in the first direction so as to feed a predetermined number of units to the dispenser.

16. A hand held medicine dosing and dispensing device according to claim 4, wherein the drive motor forms part of the ejection mechanism and is controllable to drive the feed wheel to rotate in a second direction to disengage the latch members and allow removal of the cassette from the housing.

17. A hand held medicine dosing and dispensing device according to claim 16 wherein the feed wheel includes a drive shaft and the drive motor includes a drive gear engageable within an end of the drive shaft, the end of the drive shaft defining a pair of sloped contact surfaces, each contact surface terminating in a shoulder against which the drive gear engages on rotation in a first direction and the sloped contact surfaces defining cam surfaces along which the drive gear travels causing movement of the cassette relative to the housing on rotation of the drive motor in the second direction to disengage the latch members.

18. A hand held medicine dosing and dispensing device according to claim 16 wherein the ejection mechanism further includes at least one biasing member to eject the cassette from the housing on disengagement of the latch members.

19. A hand held medicine dosing and dispensing device according to claim 4, wherein the feed wheel defines the actuating mechanism and the impacter is operably associated at or towards its second end with the feed wheel.

20. A hand held medicine dosing and dispensing device according to claim 19 wherein the feed wheel includes a plurality of equidistantly spaced fins protruding outwardly from its outer circumference, adjacent fins defining the feed pockets therebetween such that rotation of the feed wheel in the first direction moves each of the fins sequentially into engagement with a front face of the second end of the impacter and continued rotation of the feed wheel causes deflection of the second end of the impacter towards the wall of the storage chamber as the respective fin is moved across the front face of the second end of the impacter and out of engagement therewith.

21. A hand held medicine dosing and dispensing device according to claim 20 wherein rotation of the feed wheel in the second direction moves an adjacent one of the fins into engagement with a second face of the second end of the impacter such that the second end of the impacter blocks further rotation of the feed wheel in the second direction.

22. A hand held medicine dosing and dispensing device according to claim 4 wherein the impacter is formed from a magnetic material and the actuating mechanism includes an electro-magnet selectively operable to cause deflection of the second end of the impacter towards the wall of the storage chamber.

23. A hand held medicine dosing and dispensing device according to claim 4 wherein the dosing and dispensing device includes a controller to control operation of the dosing and dispensing device.

24. A hand held medicine dosing and dispensing device according to claim 23 wherein the controller is programmable to dispense a predetermined number of units of medicine at one or more predetermined times.

25. A hand held medicine dosing and dispensing device according to claim 23 wherein the dosing and dispensing device further includes a display to display information to a user.

26. A hand held medicine dosing and dispensing device according to claim 23 wherein the dosing and dispensing device further includes a data input device to enter data into the controller and effect operation of the dosing and dispensing device in accordance with the input data.

27. A hand held medicine dosing and dispensing device according to claim 25 wherein the display and the data input device are provided in the form of a touch-sensitive screen.

28. A hand held medicine dosing and dispensing device according to claim 27 wherein a visual analogue scale (VAS) is selectively displayed on the screen to facilitate the input of data.

29. A hand held medicine dosing and dispensing device according to claim 28 wherein the visual analogue scale (VAS) is displayed on the screen when the dosing and dispensing device dispenses one or more units of medicine.

30. A hand held medicine dosing and dispensing device according to claim 26 wherein the dosing and dispensing device further includes a memory to store data input via the data input device.

31. A hand held medicine dosing and dispensing device according to claim 4 further including an alarm that emits sound or light, and/or causes the dosing and dispensing device to vibrate at one or more predetermined times.

32. A hand held medicine dosing and dispensing device according to claim 4 further including a lock to prevent unauthorized dispensing of units of medicine.

33. A hand held medicine dosing and dispensing device according to claim 23 when dependent on claim 2 wherein the cassette includes a readable marker and the dosing and dispensing device further includes a reader to read the marker and thereby allow the controller to identify the medicine contained in the cassette.

34. A hand held medicine dosing and dispensing device according to claim 4 wherein the storage chamber allows the storage of discrete units of medicine where each unit of medicine is provided in the form of tablets or pellets having convex or iso-diametrical shape.

35-40. (canceled)
